(19) United States
(12) Patent Application Publication
(10) Pub. No.: US 2026/0369592 A1
(43) Pub. Date: Nov. 19, 2026

(54) POSITIVE ELECTRODE ACTIVE MATERIAL AND BATTERY

(71) Applicant: TOYOTA JIDOSHA KABUSHIKI KAISHA, Toyota-shi (JP)

(72) Inventor: Ryosuke OHSAWA, Okazaki-shi (JP)

(73) Assignee: TOYOTA JIDOSHA KABUSHIKI KAISHA, Toyota-shi (JP)

(21) Appl. No.: 19/638,305

(22) Filed: Apr. 3, 2026

(30) Foreign Application Priority Data
May 16, 2025 (JP) 2025-082383

(51) Int. Cl. H01M 4/525; H01M 4/02

(52) U.S. Cl. CPC H01M 4/525; H01M 2004/028

(57) ABSTRACT

The present disclosure relates to a positive electrode active material and a battery. The present disclosure provides a positive electrode active material including crystalline primary particles containing Li, a transition metal (TM), and O, in which La, W, and S are detected on a surface of the primary particles by TEM-EDX measurement.

### CROSS-REFERENCE TO RELATED APPLICATION

This application claims priority to Japanese Patent Application No. 2025-082383 filed on May 16, 2025. The disclosure of the above-identified application, including the specification, drawings, and claims, is incorporated by reference herein in its entirety.

### BACKGROUND

### 1. Technical Field

The present disclosure relates to a positive electrode active material and a battery.

### 2. Description of Related Art

In recent years, development of a battery has been actively carried out. For example, in the automotive industry, development of a battery used in a battery electric vehicle (BEV), a plug-in hybrid electric vehicle (PHEV), or a hybrid electric vehicle (HEV) has been carried out. As a positive electrode active material used in a battery, an active material containing a transition metal such as Ni, Co, and Mn is known.

For example, Japanese Unexamined Patent Application Publication (Translation of PCT Application) No. 2022-542774 (JP 2022-542774 A) discloses a W-containing high-nickel ternary positive electrode material having a chemical formula of LiₐNiₓCo_{y}Mn_{1-x-y}W_{b}M_{c}O₂. The high-nickel ternary positive electrode material contains spherical secondary particles and single crystal form particles at the same time. A W element is basically not contained in the single crystal form particles. The W element is doped in the spherical secondary particles.

Japanese Unexamined Patent Application Publication (Translation of PCT Application) No. 2024-511223 (JP 2024-511223 A) discloses a single crystal multi-element positive electrode material. A ratio of the length of a longest diagonal line to the length of a shortest diagonal line that are measured by SEM on a single crystal particle of the single crystal multi-element positive electrode material is defined as a true circularity R. R is 1 or more. D₁₀, D₅₀, and D₉₀ of the single crystal particle of the single crystal multi-element positive electrode material satisfy K₉₀=(D₉₀−D₁₀)/D₅₀. A product of K₉₀ and R is 1.20 to 1.40.

### SUMMARY

From the viewpoint of improving battery performance, it is desired to reduce resistance. The present disclosure has been made in view of the above circumstances, and a main object thereof is to provide a positive electrode active material having reduced resistance.
[1] A positive electrode active material including
   a primary particle that is crystalline, the primary particle containing Li, TM (TM is a transition metal), and O,
   in which La, W, and S are detected on a surface of the primary particle by TEM-EDX measurement.
[2] The positive electrode active material according to [1],
   in which the positive electrode active material includes an overlapping region X in which La and S are both present in an element mapping image acquired by SEM-EDX measurement.
[3] The positive electrode active material according to [1] or [2], in which the positive electrode active material includes an overlapping region Y in which W and S are both present in an element mapping image acquired by SEM-EDX measurement.
[4] The positive electrode active material according to any one of [1] to [3], in which the primary particle contains at least one of Ni, Co, and Mn as TM.
[5] A battery including
   a positive electrode active material layer,
   a negative electrode active material layer, and
   an electrolyte layer disposed between the positive electrode active material layer and the negative electrode active material layer,
   in which the positive electrode active material layer contains the positive electrode active material according to any one of [1] to [4].

The present disclosure can provide a positive electrode active material having reduced resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating the positive electrode active material in the present disclosure;

FIG. 2 is a flowchart illustrating a method of manufacturing the positive electrode active material in the present disclosure; and

FIG. 3 is a schematic cross-sectional view illustrating a battery in the present disclosure.

### DETAILED DESCRIPTION OF EMBODIMENTS

Hereinafter, embodiments will be described with reference to the drawings or the like; however, the present disclosure can be implemented in many different aspects, and the description of the embodiments exemplified below is not intended to limit the present disclosure. In addition, in order to make the description clearer, the drawings may schematically show the width, thickness, and shape of each part as compared with the actual form, but this is merely an example and is not intended to be limiting.

### A. Positive Electrode Active Material

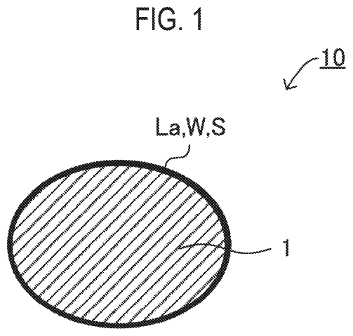

FIG. 1 is a schematic cross-sectional view illustrating the positive electrode active material in the present disclosure. As shown in FIG. 1, a positive electrode active material 10 has a crystalline primary particle 1 containing Li, TM (TM is a transition metal), and O. In the positive electrode active material 10, La, W, and S are detected on a surface of the primary particles 1 by TEM-EDX measurement. That is, La, W, and S are present on the surface of the primary particles 1. La, W, and S may be uniformly present on an entirety of the surface of the primary particles 1 or may be unevenly present in a part thereof.

In the positive electrode active material in the present disclosure, La that contributes to improvement of electron conductivity and W that contributes to improvement of ion conductivity are present on the surface of the primary particles. Further, S present on the surface of the primary particles exhibits a dielectric effect during pressure application. Accordingly, with the positive electrode active material in the present disclosure, electron resistance and reaction resistance can be reduced, and a positive electrode active material having reduced resistance can be obtained.

In Embodiment 3 of JP 2022-542774 A, a positive electrode material represented by Li_{1.0029}Ni_{0.83}Co_{0.11}Mn_{0.06} W_{0.0009}La_{0.002}O₂ is disclosed. However, JP 2022-542774 A does not describe or suggest that La, W, and S are present on the surface of the primary particles of the positive electrode material.

In addition, JP 2024-511223 A discloses a positive electrode material represented by Li₁₊ₐ(NiₓCo_{y}Mn_{z}G_{b}) M_{c}O_{2-d}. It is disclosed that G is one or a plurality of kinds of Ti, W, V, Ta, Zr, La, Ce, Er, Sr, Si, Al, B, Mg, Co, F, and Y. That is, as one of the options of G, La is disclosed. However, J P 2024-511223 A does not disclose any embodiment using La, W, and S at all.

### 1. Primary Particle

The primary particle in the present disclosure is a crystalline particle containing Li, TM (TM is a transition metal), and O. Examples of the crystal structure of the primary particle include a layered rock salt type and a spinel type, and a layered rock salt type is preferable. In addition, the primary particle may have a crystal structure belonging to a space group R-3m.

The primary particle contains Li, TM (TM is a transition metal), and O. The primary particle may contain one kind of transition metal, may contain two kinds of transition metals, may contain three kinds of transition metals, or may contain four or more kinds of transition metals.

The transition metal is a metal belonging to Group 3 to Group 11 in the periodic table. The transition metal contained in the primary particle may be a metal belonging to the third period, the fourth period, or the fifth period. Examples of the transition metal include Ti, V, Cr, Mn, Fe, Co, Ni, Zr, Nb, La, and W.

It is preferable that the primary particle contains at least Ni. This is because a positive electrode active material having favorable capacity characteristics can be obtained. In a case where all the transition metals contained in the primary particles are set to 1 part by mole, a proportion of Ni contained in the primary particles is, for example, 0.25 parts by mole or more. The proportion of Ni may be 0.33 parts by mole or more, 0.50 parts by mole or more, 0.75 parts by mole or more, 0.80 parts by mole or more, or 0.90 parts by mole or more. By increasing the proportion of Ni, the capacity characteristics are improved.

The primary particle may contain Co or may not contain Co. In a case where all the transition metals contained in the primary particle are defined as 1 part by mole, a proportion of Co contained in the primary particle is, for example, 0 parts by mole or more, and may be 0.05 parts by mole or more, or 0.10 parts by mole or more. On the other hand, the proportion of Co contained in the primary particle is, for example, 0.40 parts by mole or less, and may be 0.20 parts by mole or less.

The primary particle may contain Mn or may not contain Mn. In a case where all the transition metals contained in the primary particle are defined as 1 part by mole, a proportion of Mn contained in the primary particle is, for example, 0 parts by mole or more, and may be 0.05 parts by mole or more, or 0.10 parts by mole or more. On the other hand, the proportion of Mn contained in the primary particle is, for example, 0.40 parts by mole or less, and may be 0.20 parts by mole or less.

It is preferable that the primary particle contains at least one of Ni, Co, or Mn. In a case where all the metals (excluding Li) contained in the primary particles are set to 1 part by mole, a total proportion of Ni, Co, and Mn contained in the primary particles is, for example, 0.80 parts by mole or more. The proportion may be 0.90 parts by mole or more or 0.95 parts by mole or more. In addition, the “total of Ni, Co, and Mn” includes a case where the proportion of one or two of Ni, Co, and Mn is 0.

The primary particle may contain, in addition to Li and TM, another metal M¹ (including a metalloid) other than Li and TM. Examples of the other metal M¹ include a metal belonging to Group 12 to Group 14 in the periodic table. Examples of the metal belonging to Group 12 to Group 14 include Zn, Al, Si, Ga, Ge, In, and Sn.

A composition of the primary particles is not particularly limited, but may be, for example, a composition represented by General Formula LiₓNiₐCo_{b}Mn_{c}O_{y} (0.1≤x≤1.5, 0.5≤a≤1.0, 0≤b≤0.3, 0≤c≤0.3, a+b+c=1.0, 1.5≤y≤2.1).
“x” may be 0.4 or more, 0.6 or more, 0.8 or more, 1.0 or more, or 1.05 or more, and may be 1.4 or less or 1.2 or less.
“y” may be 1.6 or more, 1.7 or more, 1.8 or more, or 1.9 or more, and may be 2.0 or less.
“a” may be 0.6 or more, 0.7 or more, 0.8 or more, or 0.85 or more, and may be 0.9 or less.
“b” may be 0.01 or more, 0.02 or more, 0.03 or more, 0.04 or more, 0.05 or more, 0.06 or more, 0.07 or more, or 0.075 or more. “b” may be 0.25 or less, 0.20 or less, 0.15 or less, 0.10 or less, 0.09 or less, or 0.08 or less.
“c” may be 0.01 or more, 0.02 or more, 0.03 or more, 0.04 or more, 0.05 or more, 0.06 or more, 0.07 or more, or 0.075 or more. “c” may be 0.25 or less, 0.20 or less, 0.15 or less, 0.10 or less, 0.09 or less, or 0.08 or less.

The positive electrode active material in the present disclosure may be a single crystal type active material composed of the primary particles, or may be a polycrystal in which a plurality of primary particles is aggregated. The single crystal type active material is not a so-called polycrystalline active material (an active material in which a large number of primary particles are aggregated without a gap). The single crystal-based active material is usually not aggregated and exists as one independent particle. In the single crystal-based active material, grain boundaries are preferably not confirmed in a scanning electron microscope (SEM) observation (magnification: about 10,000 to 30,000 times). The single crystal type active material has an advantage of less deterioration over time than the polycrystalline active material.

A particle diameter of the primary particle is, for example, 0.5 μm or more, and may be 0.6 μm or more, 0.8 μm or more, or 1.0 μm or more. On the other hand, the particle diameter of the primary particle is, for example, 20 μm or less, and may be 15 μm or less, 10 μm or less, or 5 μm or less. The particle diameter of the primary particle is obtained, for example, as a longest diameter in SEM observation. In addition, for example, in a case where the primary particle (positive electrode active material) is contained in the positive electrode active material layer, the particle diameter (longest diameter) of the primary particle may be obtained from a cross-sectional image of the positive electrode active material layer.

### 2. La, W, and S

In the positive electrode active material in the present disclosure, La, W, and S are detected on the surface of the primary particles by measurement with a transmission electron microscope-energy dispersive X-ray spectroscopy (TEM-EDX). La contributes to improvement of electron conductivity, and W contributes to improvement of ion conductivity. Further, S exhibits a dielectric effect during pressure application in a case of being used as a battery, and can reduce electron resistance and reaction resistance.

La, W, and S may be uniformly present on an entirety of the surface of the primary particles or may be unevenly present in a part of the surface of the primary particles.

In the positive electrode active material in the present disclosure, it is preferable that La and S are present at the same location. For example, it is preferable that the positive electrode active material has an overlapping region X in which La and S are both present in an element mapping image acquired by measurement with SEM-EDX. The expression “having an overlapping region X” means that a proportion (R₁/(R_{La}+R_{S})) of a total area R₁ of a region in which La and S are both present to a total area R_{La} of a region in which La is present and a total area R_{S} of a region in which S is present in an element mapping image of the positive electrode active material (10 particles) acquired by the SEM-EDX measurement is 5% or more. By being present at the same location, La and S can further reduce the resistance.

In the positive electrode active material in the present disclosure, it is preferable that W and S are present at the same location. For example, it is preferable that the positive electrode active material has an overlapping region Y in which W and S are both present in an element mapping image acquired by measurement with SEM-EDX measurement. The expression “having an overlapping region Y” means that a proportion (R₂/(R_{W}+R_{S})) of a total area R₂ of a region in which W and S are both present to a total area R_{W} of a region in which W is present and a total area R_{S} of a region in which S is present in an element mapping image of the positive electrode active material (10 particles) acquired by the SEM-EDX measurement is 5% or more. By being present at the same location, W and S can further reduce the resistance.

In the positive electrode active material in the present disclosure, it is preferable to have both the overlapping region X and the overlapping region Y. This is because the resistance can be further reduced. In this case, at least a part of the overlapping region X and the overlapping region Y may overlap with each other. In this case, it can be said that La, W, and S are present at the same location in the positive electrode active material in the present disclosure. On the other hand, the overlapping region X and the overlapping region Y may not overlap with each other.

### (1) La

In the positive electrode active material in the present disclosure, La is detected on the surface of the primary particles by TEM-EDX measurement. The primary particles may contain La or may not contain La.

In a case where all the transition metals contained in the primary particle are defined as 1 part by mole, a proportion of La contained in the positive electrode active material is, for example, 0.001 parts by mole or more, and may be 0.003 parts by mole or more, or 0.005 parts by mole or more. On the other hand, the above-described proportion of La contained in the positive electrode active material is, for example, 0.100 parts by mole or less, and may be 0.050 parts by mole or less or 0.030 parts by mole or less.

A coating rate of La on the primary particle is not particularly limited, but is, for example, 10% or more and 90% or less, and may be 20% or more and 80% or less, or 30% or more and 70% or less. The coating rate of La can be obtained from, for example, an outermost surface analysis by X-ray photoelectron spectroscopy (XPS). For example, in a case where the primary particle contains Ni, Co, and Mn as the transition metal TM, the amount of La and the amount of each TM (amount of Ni, amount of Co, amount of Mn) can be obtained by the outermost surface analysis by XPS, and La/(La+TM) can be used as the coating rate. The coating rates of W and S can also be obtained in the same manner.

La may be present as a La compound containing La and other elements. Examples of the other elements include Ni, Li, O, W, and S. The La compound may be directly disposed on the surface of the primary particles or may be disposed through another layer (another compound).

The La compound may be a compound A containing La, Ni, and O. The compound A contains at least La, Ni, and O. The compound A may further contain other elements. Examples of the composition of the compound A include LaₐNi_{b}O_{c} (0.8≤a≤1.2, 0.8≤b≤1.2, 2.8≤c≤3.2). For example, LaNiO₃ has a typical perovskite composition and has favorable electron conductivity. Examples of the composition of the compound A include LaₐLi_{b}Ni_{c}O_{d} (3.5≤a≤4.5, 0.5≤b≤1.5, 0.5≤c≤1.5, 7.5≤d≤8.5). For example, it is known that La₄LiNiO₈ has favorable electron conductivity, and a crystal phase similar to perovskite is provided.

The La compound may be a compound containing La and at least one of W or S.

### (2) W

In the positive electrode active material in the present disclosure, W is detected on the surface of the primary particles by TEM-EDX measurement. In the TEM-EDX measurement, W is unevenly present on, for example, the surface of the primary particles. The primary particles may contain W or may not contain W.

In a case where all the transition metals contained in the primary particle are defined as 1 part by mole, a proportion of W contained in the positive electrode active material is, for example, 0.001 parts by mole or more, and may be 0.003 parts by mole or more, or 0.005 parts by mole or more. On the other hand, the above-described proportion of W contained in the positive electrode active material is, for example, 0.100 parts by mole or less, and may be 0.050 parts by mole or less or 0.030 parts by mole or less.

A coating rate of W on the primary particle is not particularly limited, but is, for example, 10% or more and 90% or less, and may be 20% or more and 80% or less, or 30% or more and 70% or less.

W may be present as a W compound containing W and other elements. Examples of the other elements include Li, O, La, and S. The W compound may be directly disposed on the surface of the primary particles or may be disposed through another layer (another compound), but the former is preferable.

The W compound may be, for example, a compound B containing Li, W, and O. The compound B contains at least Li, W, and O. The compound B may be composed of only Li, W, and O, or may further contain other elements. Examples of the composition of the compound B include LiₐW_{b}O_{c} (5.5≤a≤6.5, 0.5≤b≤1.5, 5.5≤c≤6.5). The compound B having the above composition is typically Li₆WO₆. Examples of the composition of the compound B include LiₐW_{b}O_{c} (1.5≤a≤2.5, 0.5≤b≤1.5, 3.5≤c≤4.5). The compound B having the above composition is typically Li₂WO₄. In addition, examples of the composition of the compound B include LiₐW_{b}O_{c} (3.5≤a≤4.5, 0.5≤b≤1.5, 4.5≤c≤5.5). The compound B having the above composition is typically Li₄WO₅. In addition, examples of the composition of the compound B include LiₐW_{b}O_{c} (1.5≤a≤2.5, 1.5≤b≤2.5, 6.5≤c≤7.5). The compound B having the above composition is typically Li₂W₂₀₇.

In addition, the ion conductivity of the compound B is usually higher than the ion conductivity of W₂O₃. The ion conductivity of the compound B at 25 °C is, for example, 1.0×10⁻⁵ S/cm or more, and may be 1.0×10⁻⁴ S/cm or more. The compound B may be crystalline or amorphous.

The W compound may be a compound containing W and at least one of La or S.

### (3) S

In the positive electrode active material in the present disclosure, S is detected on the surface of the primary particles by TEM-EDX measurement. In the TEM-EDX measurement, S is unevenly present on, for example, the surface of the primary particles. The primary particles may contain S or may not contain S.

In a case where all the transition metals contained in the primary particle are defined as 1 part by mole, a proportion of S contained in the positive electrode active material is, for example, 0.001 parts by mole or more, and may be 0.005 parts by mole or more, or 0.01 parts by mole or more. On the other hand, the above-described proportion of S present on the surface of the primary particles is, for example, 0.100 parts by mole or less, and may be 0.050 parts by mole or less.

A coating rate of S on the primary particle is not particularly limited, but is, for example, 10% or more and 90% or less, and may be 20% or more and 80% or less, or 30% or more and 70% or less.

S may be present as an S compound containing S. S may be present by forming a compound with at least one of La or W.

### 3. Manufacturing Method

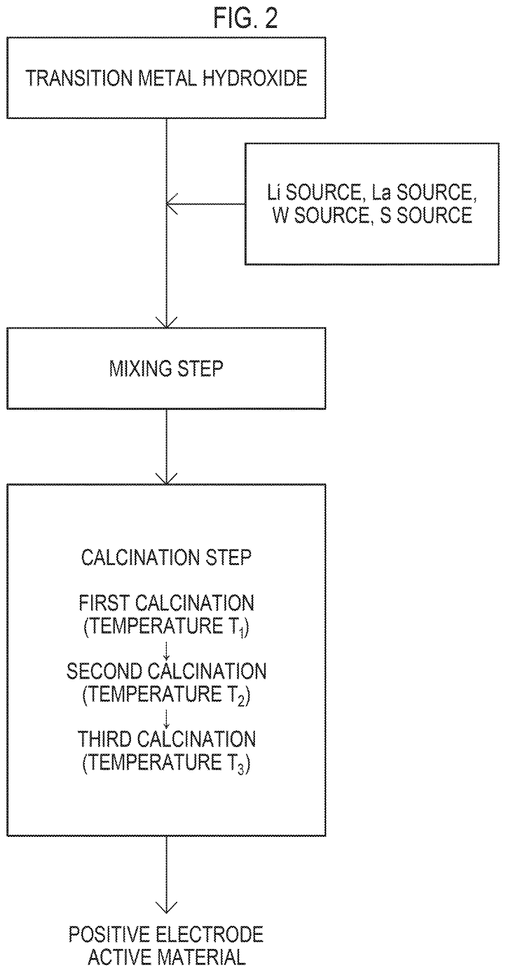

FIG. 2 is a flowchart illustrating the method of manufacturing the positive electrode active material described above. The method of manufacturing the positive electrode active material illustrated in FIG. 2 includes a mixing step of mixing a transition metal hydroxide containing a TM, a Li source, a La source, a W source, and an S source to obtain a mixture, and a calcination step of calcining the obtained mixture. The calcination step includes a first calcination treatment of being calcined at a temperature T₁, a second calcination treatment of being calcined at a temperature T₂ higher than the temperature T₁ after the first calcination treatment, and a third calcination treatment of being calcined at a temperature T₃ higher than the temperature T₂ after the second calcination treatment. The temperature T₁ is preferably higher than a melting point of the La source and a melting point of the W source. As a result, the positive electrode active material is obtained.

### (1) Mixing Step

The transition metal hydroxide contains TM (TM is a transition metal). The transition metal hydroxide corresponds to a precursor of the positive electrode active material. The transition metal hydroxide does not contain Li in general, but may contain Li. A method of synthesizing the transition metal hydroxide is not particularly limited, but examples thereof include the following methods. First, an aqueous raw material solution of the transition metal hydroxide is prepared. Examples of a method of preparing the aqueous raw material solution include a method of dissolving a water-soluble transition metal compound in water. Examples of the transition metal compound include metal salts such as a sulfate and a nitrate. Examples of the Ni source include NiSO₄ and Ni(NO₃)₂. Examples of the Co source include CoSO₄, Co(NO₃)₂, and Co(NO₃)₃. Examples of the Mn source include MnSO₄ and Mn(NO₃)₂. A composition of the aqueous raw material solution is appropriately adjusted corresponding to a positive electrode active material to be obtained. A certain amount of an NH₃ aqueous solution is put into a reaction container, and nitrogen substitution is performed while stirring with a stirrer or the like. Next, a sodium hydroxide aqueous solution is added to the reaction container, and the aqueous raw material solution and the NH₃ aqueous solution are added dropwise while maintaining the pH in an alkaline range (for example, pH 11.3 to 12.0). A reaction temperature is not particularly limited, but is, for example, 50 °C or higher and 65 °C or lower. A reaction time is, for example, 2 hours or longer and 6 hours or shorter. After the reaction is completed, it is preferable to filter the reaction solution to take out the transition metal hydroxide, and then wash the transition metal hydroxide with water and dry the transition metal hydroxide.

In the mixing step, a mixture containing the transition metal hydroxide, the Li source, the La source, the W source, and the S source is produced. Examples of the Li source include lithium hydroxide, lithium carbonate, lithium nitrate, lithium acetate, lithium oxide, and lithium chloride. The Li source may be lithium hydroxide or may be a Li-containing compound other than lithium hydroxide. A molar ratio of Li in the Li source to TM contained in the transition metal hydroxide is, for example, 0.8 or more and 1.2 or less, and may be 0.9 or more and 1.1 or less, or may be 1.0.

Examples of the La source include a hydroxide; and a metal salt such as a sulfate and a nitrate. Examples of the La source include La(OH)₃, LaSO₄, and La(NO₃)₃. A molar ratio of La in the La source to the TM contained in the transition metal hydroxide is, for example, 0.005 or more and 0.02 or less, and may be 0.008 or more and 0.015 or less. Examples of the W source include H₂WO₄. A molar ratio of W in the W source to the TM contained in the transition metal hydroxide is, for example, 0.005 or more and 0.02 or less, and may be 0.008 or more and 0.015 or less. Examples of the S source include Li₂SO₄. A molar ratio of S in the S source to the TM contained in the transition metal hydroxide is, for example, 0.001 or more and 0.10 or less, and may be 0.01 or more and 0.05 or less.

The mixture preferably has a molten salt. By functioning as a flux, the molten salt can sufficiently grow the primary particles. The molten salt may contain Li. Examples of the molten salt include lithium hydroxide. The mixture may contain lithium hydroxide as the Li source and the molten salt. A molar ratio (Li′/TM) of Li in the Li source and the molten salt to the TM contained in the transition metal hydroxide is, for example, 1.01 or more, and may be 1.05 or more, 1.10 or more, or 1.15 or more. On the other hand, Li′/TM is, for example, 1.60 or less, and may be 1.50 or less, 1.40 or less, or 1.30 or less.

### (2) Calcination Step

In the first calcination treatment, the first mixture is calcined at a temperature T₁. The temperature T₁ is preferably higher than a melting point of the La source and a melting point of the W source, and is, for example, 300 °C or higher and 400 °C or lower. It is noted that a melting point of La(OH)₃ is 260 °C, a melting point of H₂WO₄ is 100 °C, and a melting point of Li₂SO₄ is 850 °C. By holding at the temperature Ti and then calcining at the temperature T₂ and the temperature T₃, it is possible to promote contact between the raw materials, and it is easy to obtain a positive electrode active material in which La and S are present at the same location or W and S are present at the same location. A calcination time at the temperature T₁ is, for example, 2 hours or longer and 4 hours or shorter. The temperature T₂ is, for example, 400 °C or higher and 600 °C or lower. A calcination time at the temperature T₂ is, for example, 2 hours or longer and 4 hours or shorter. The temperature T₃ is, for example, 800 °C or higher and 1,000 °C or lower. A calcination time at the temperature T₃ is, for example, 8 hours or longer and 12 hours or shorter. An atmosphere in the first calcination treatment, the second calcination treatment, and the third calcination treatment is usually an atmosphere in which oxygen is present, and examples of a calcination method include a method of using a calcining furnace such as a muffle furnace and an electric furnace.

### B. Battery

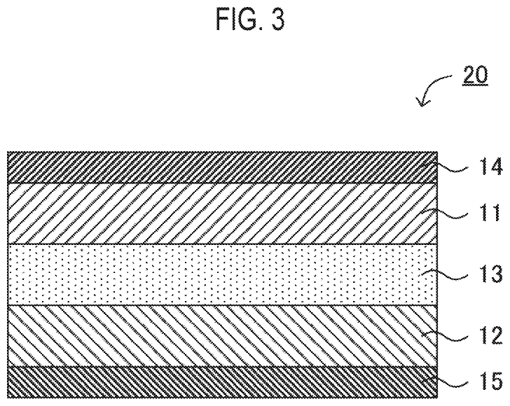

FIG. 3 is a schematic cross-sectional view illustrating a battery in the present disclosure. A battery 20 illustrated in FIG. 3 includes a positive electrode active material layer 11 having the above-described positive electrode active material, a negative electrode active material layer 12, an electrolyte layer 13 disposed between the positive electrode active material layer 11 and the negative electrode active material layer 12, a positive electrode collector 14 that collects the positive electrode active material layer 11, and a negative electrode collector 15 that collects the negative electrode active material layer 12. Since the positive electrode active material layer 11 has the above-described positive electrode active material, a battery having reduced resistance is obtained.

The positive electrode active material layer contains the positive electrode active material described in “A. Positive Electrode Active Material”. In addition, the positive electrode active material layer may contain a conductive material and a binder. As the conductive material and the binder, conventionally known materials can be used. The positive electrode active material layer may contain an electrolyte. The electrolyte is, for example, an electrolytic solution described later. A thickness of the positive electrode active material layer is, for example, 0.1 μm or more and 1,000 μm or less. A method of producing the positive electrode active material layer is not particularly limited, and examples thereof include a method of applying a positive electrode slurry containing the positive electrode active material and a dispersion medium to the positive electrode collector and drying the positive electrode collector. A press treatment may be performed on the positive electrode active material layer after drying. By the press treatment, a density of the positive electrode active material layer is improved.

The negative electrode active material layer contains at least the negative electrode active material. Examples of the negative electrode active material include a carbon-based active material, an Li-based active material, an Si-based active material, and an oxide-based active material. The negative electrode active material layer may contain at least one of a conductive material, a binder, or an electrolyte. Details of the conductive material, the binder, and the electrolyte are the same as those described above.

The electrolyte layer contains at least an electrolyte. The electrolyte is, for example, a liquid electrolyte (electrolytic solution). Examples of the electrolytic solution include a non-aqueous electrolytic solution. The non-aqueous electrolytic solution contains, for example, a lithium salt and a non-aqueous solvent. Examples of the lithium salt include inorganic lithium salts such as LiPF₆, LiBF₄, LiClO₄, and LiAsF₆; and organic lithium salts such as LiCF₃SO₃, LiN(SO₂CF₃)₂, LiN(SO₂C₂F₅)₂, and LiC(SO₂CF₃)₃. Examples of the non-aqueous solvent include a carbonate-based solvent. The non-aqueous solvent may be a mixture of cyclic carbonates such as EC and PC having a high dielectric constant and a high viscosity, and chain-shaped carbonates such as DMC, DEC, and EMC having a low dielectric constant and a low viscosity. In addition, the non-aqueous electrolytic solution may contain an ionic liquid. Examples of the electrolytic solution include an aqueous electrolytic solution.

Examples of a material for the positive electrode current collector include SUS, aluminum, nickel, iron, titanium, and carbon. Meanwhile, examples of a material for the negative electrode current collector include SUS, copper, nickel, and carbon.

A type of the battery in the present disclosure is not particularly limited, but is typically a lithium ion battery. In addition, the battery in the present disclosure may be a primary battery or a secondary battery, but is preferably a secondary battery. This is because the battery can be repeatedly charged and discharged and is useful as, for example, a vehicle-mounted battery. Examples of an application of the battery include a power source of a vehicle such as a hybrid electric vehicle (HEV), a plug-in hybrid electric vehicle (PHEV), a battery electric vehicle (BEV), a gasoline vehicle, and a diesel vehicle. In particular, it is preferably used as a power source for driving a hybrid electric vehicle (HEV), a plug-in hybrid electric vehicle (PHEV), or a battery electric vehicle (BEV). In addition, the battery may be used as a power source of a moving object (for example, a railway, a ship, or an aircraft) other than a vehicle, or may be used as a power source of an electric product such as an information processing apparatus.

The present disclosure is not limited to the above-described embodiment. The above-described embodiment is an example, and any configuration having a substantially same configuration as the technical idea described in the claims of the present disclosure and exhibiting the same action and effect is included in the technical scope of the present disclosure.

### Comparative Example 1

### Production of Positive Electrode Active Material

As a raw material, NiSO₄, CoSO₄, and MnSO₄ were prepared, and these were dissolved in ion exchange water to prepare a raw material aqueous solution. A proportion of Ni, Co, and Mn in the raw material aqueous solution was set to Ni:Co:Mn=8:1:1 in terms of molar ratio. In addition, a concentration of the raw material aqueous solution (proportion of all raw materials to the raw material aqueous solution) was 30% by mass.

Thereafter, a certain amount of an NH₃ aqueous solution was added to the reaction container, and the inside of the reaction container was replaced with nitrogen while stirring with a stirrer. A NaOH aqueous solution was added to the reaction container, the pH was maintained in an alkaline range, and the raw material aqueous solution and the NH₃ aqueous solution were added dropwise while controlling the temperature to a certain temperature, thereby precipitating the transition metal hydroxide. The reaction temperature was set to 60 °C, and the reaction time was set to 3 hours. Next, the precipitated transition metal hydroxide was taken out by filtration, and washed with water by adding ion exchange water and dispersing with a spoon. After the washing with water, the transition metal hydroxide obtained by filtration was dried under the conditions of 120 °C and 16 hours to obtain a transition metal hydroxide as a precursor.

Thereafter, a Li source (LiOH), a La source (La(OH)₃), and a W source (H₂WO₄) were added to the obtained precursor, and mixed in a mortar to obtain a mixture (mixing step). An addition amount of the Li source was adjusted such that a molar ratio (Li/NCM) of Li contained in the Li source to the total of Ni, Co, and Mn contained in the precursor (NCM) was 1.1. In addition, the addition amount of the La source was adjusted such that La/NCM was 0.01, and the addition amount of the W source was adjusted such that W/NCM was 0.01. The obtained mixture was calcined in a firing furnace under the conditions of 900 °C, an oxygen atmosphere, and 10 hours to obtain a calcined body. The obtained calcined body was crushed using a jet mill to adjust the particle diameter, thereby obtaining a positive electrode active material.

### Production of Battery

A battery was produced using the obtained positive electrode active material. Specifically, a positive electrode mixture paste containing the positive electrode active material (LiNi_{0.8}Co_{0.1}Mn_{0.1}O₂), a conductive material (acetylene black), and a binder (polyvinylidene fluoride) at a mass ratio of positive electrode active material:conductive material:binder=88:10:2 was applied onto a surface of a metal foil which was a positive electrode collector, using a film applicator with a film thickness adjustment function (manufactured by Allgrid Co., Ltd.). Thereafter, the positive electrode mixture was dried at 80 °C for 5 minutes in a dryer to obtain a positive electrode having a positive electrode collector and a positive electrode active material layer.

Next, a negative electrode mixture paste containing a negative electrode active material (natural graphite) and a binder (SBR and CMC) was applied onto a surface of a metal foil which was a negative electrode collector, using a film applicator with a film thickness adjustment function (manufactured by Allgrid Co., Ltd.). Thereafter, the negative electrode mixture was dried at 80 °C for 5 minutes in a dryer to obtain a negative electrode having a negative electrode collector and a negative electrode active material layer. Next, as an electrolytic solution, a LiPF₆ solution having a concentration of 1 M was prepared. As a solvent of the electrolytic solution, a mixed solvent obtained by mixing ethylene carbonate (EC), dimethyl carbonate (DMC), and ethyl methyl carbonate (EMC) at a volume ratio of EC:DMC:EMC=3:4:3 was used. A wound cylindrical battery was obtained using the positive electrode, the negative electrode, and the electrolytic solution.

### Embodiment 1

A precursor (transition metal hydroxide) was obtained in the same manner as in Comparative Example 1. A Li source (LiOH), a La source (La(OH)₃), a W source (H₂WO₄), and a S source (Li₂SO₄) were added to the obtained precursor, and mixed in an agate mortar to obtain a mixture (mixing step). An addition amount of the Li source was adjusted such that a molar ratio (Li/NCM) of Li contained in the Li source to the total of Ni, Co, and Mn contained in the precursor (NCM) was 1.1. In addition, the addition amount of the La source was adjusted such that La/NCM was 0.01, and the addition amount of the W source was adjusted such that W/NCM was 0.01. In addition, the addition amount of the S source was adjusted such that S/NCM was 0.001. The obtained mixture was calcined in a calcining furnace in an oxygen atmosphere at 300 °C for 3 hours (first calcination treatment), 500 °C for 3 hours (second calcination treatment), and 800 °C for 10 hours (third calcination treatment) in this order to obtain a calcined body (calcination step). The obtained calcined body was crushed using a jet mill to adjust the particle diameter, thereby obtaining a positive electrode active material. A battery was obtained in the same manner as in Comparative Example 1, except that the obtained positive electrode active material was used.

### Embodiment 2

A positive electrode active material was obtained by the same method as in Embodiment 1, except that in the mixing step, the addition amount of the S source was adjusted such that S/NCM was 0.01. A battery was obtained in the same manner as in Comparative Example 1, except that the obtained positive electrode active material was used.

### Embodiment 3

A positive electrode active material was obtained by the same method as in Embodiment 1, except that in the mixing step, the addition amount of the S source was adjusted such that S/NCM was 0.05. A battery was obtained in the same manner as in Comparative Example 1, except that the obtained positive electrode active material was used.

### Evaluation

### TEM-EDX Measurement

Elemental analysis of the positive electrode active material obtained in Embodiments 1 to 3 was performed by transmission electron microscope-energy dispersive X-ray spectroscopy (TEM-EDX). As a result, in the positive electrode active material of Embodiments 1 to 3, La, W, and S were detected on the surface of the primary particles.

### SEM-EDX Measurement

10 particles were randomly selected from a cross-sectional SEM image of the positive electrode active material layer, and EDX mapping images of the same field of view of the La element, the W element, and the S element were acquired. The EDX mapping images were analyzed with image analysis software (imageJ), and the presence or absence of the La element, the W element, and the S element was confirmed as two-dimensional coordinates for each pixel.
In a case where a proportion (R₁/(R_{La}+R_{S})) of a total area R₁ of a region in which La and S are both present to a total area R_{La} of a region in which La is present and a total area R_{S} of a region in which S is present satisfied the following relationship, it was determined that there was an overlapping region X.

0.05≤R₁/(R_{La}+R_{S}),

Similarly, in a case where a proportion (R₂/(R_{W}+R_{S})) of a total area R₂ of a region in which W and S are both present to a total area R_{W} of a region in which Wis present and a total area R_{S} of a region in which S is present satisfied the following relationship, it was determined that there was an overlapping region Y.

0.05≤R₂/(R_{W}+R_{S}),

It is noted that R_{La}, R_{S}, and R_{W} refer to an area of a region including a portion overlapping with other elements.

### Initial Resistance

The initial resistance was measured using the battery obtained in Comparative Example 1 and Embodiments 1 to 3. Specifically, the above-described battery was charged to 4.3 V, and then discharged to 3.7 V. Thereafter, the voltage drop (V) in a case of discharging for 10 seconds under the conditions of each C-rating of 0.1 C, 0.3 C, 0.5 C, 0.7 C, and 1.0 C at 0 °C was measured. A relationship between the voltage drop (V) and the current value was plotted, and a slope in a case of drawing an approximate straight line with a linear function was defined as a resistance (IV resistance). The results are shown in Table 1. The value of the initial resistance in Table 1 is a relative value in a case where the initial resistance of Comparative Example 1 is 100%.

TABLE 1

| | | | | | | | | Overlapping | | Initial |
|---|---|---|---|---|---|---|---|---|---|---|
| | Ratio | | | | | | | Region | | Resistance |
| | Li | Ni | Co | Mn | La | W | S | X | Y | (%) |
| Comparative | 1.1 | 0.8 | 0.1 | 0.1 | 0.010 | 0.010 | — | Absent | Absent | 100 |
| Example 1 | | | | | | | | | | |
| Embodiment 1 | 1.1 | 0.8 | 0.1 | 0.1 | 0.010 | 0.010 | 0.001 | Present | Absent | 85 |
| Embodiment 2 | 1.1 | 0.8 | 0.1 | 0.1 | 0.010 | 0.010 | 0.010 | Present | Absent | 83 |
| Embodiment 3 | 1.1 | 0.8 | 0.1 | 0.1 | 0.010 | 0.010 | 0.050 | Present | Present | 81 |

As shown in Table 1, it was confirmed that Embodiments 1 to 3 had a lower initial resistance than Comparative Example 1. It is presumed that this is because, since La is present on the surface of the primary particles, the movement of electrons is smooth, since W is present, the movement of ions is smooth, and since S is present on the surface of the primary particles, a dielectric effect is exhibited during pressure application, and the electron resistance and the reaction resistance can be reduced. In addition, it was confirmed that Embodiment 3 having the overlapping region X and the overlapping region Y had a further lower initial resistance than Embodiments 1 and 2 having only the overlapping region X.

What is claimed is:

1. A positive electrode active material comprising a primary particle that is crystalline, the primary particle containing Li, TM (TM is a transition metal), and O,
wherein La, W, and S are detected on a surface of the primary particle by TEM-EDX measurement.

2. The positive electrode active material according to claim 1, wherein the positive electrode active material includes an overlapping region X in which La and S are both present in an element mapping image acquired by SEM-EDX measurement.

3. The positive electrode active material according to claim 1, wherein the positive electrode active material includes an overlapping region Y in which W and S are both present in an element mapping image acquired by SEM-EDX measurement.

4. The positive electrode active material according to claim 1, wherein the primary particle contains at least one of Ni, Co, and Mn as TM.

5. A battery comprising:
a positive electrode active material layer;
a negative electrode active material layer; and
an electrolyte layer disposed between the positive electrode active material layer and the negative electrode active material layer,
wherein the positive electrode active material layer contains the positive electrode active material according to claim 1.
